(19) United States
(12) Patent Application Publication
(10) Pub. No.: US 2004/0192333 A1
(43) Pub. Date: Sep. 30, 2004

(54) Apparatus and method for a wireless locating device

(75) Inventor: Mohammad Minhaj Khokhar, Kuala Lumpur (MY)

Correspondence Address: Robert E. Krebs, Thelen Reid & Priest LLP, P.O. Box 640640, San Jose, CA, 95164-0640, US

(73) Assignees: Amica Technologies, Inc. (USA); Amica Technologies (Malaysia) Sdn. Bhd

(21) Appl. No.: 10/197,641

(22) Filed: Jul. 16, 2002

(51) Int. Cl. H04Q 7/20; H04B 1/38

(52) U.S. Cl. 455/456.1; 455/556.1

(57) ABSTRACT

A system for wirelessly determining that an object is within a predetermined distance from a user is envisioned. The system is made of a transmitter, associated with the object that has a transmitting circuitry that transmits a signal independently of the location of the transmitter. The system also has a receiver associated with the user. The receiver is made up of a receiving circuitry that receives the signal, and an activation circuitry that alerts the user. A logical circuitry, communicatively coupled to the receiving circuitry and the activation circuitry, determines whether the receiver is beyond the predetermined distance from the object based on characteristics of the signal. If the receiver is determined to be beyond the predetermined distance, the activation circuitry is enabled.

### FIELD OF THE INVENTION

The invention relates to the field of locating an object. In particular, it relates to a system and method for determining that an object is within a predetermined distance from a user.

### DESCRIPTION OF THE PRIOR ART

In many typical location systems, a device is attached to the object to be tracked. Upon the discovery that the object location is no longer known, a user typically actuates a wireless transmitter. The wireless device actuates some alarm associated the object. The alarm leads the user to the object. Thus, the object must be lost before it is found again.

### SUMMARY OF THE INVENTION

A system for wirelessly determining that an object is within a predetermined distance from a user is envisioned. The system is made of a transmitter, associated with the object that has a transmitting circuitry that transmits a signal independently of the location of the transmitter. The system also has a receiver associated with the user. The receiver is made up of a receiving circuitry that receives the signal, and an activation circuitry that alerts the user. A logical circuitry, communicatively coupled to the receiving circuitry and the activation circuitry, determines whether the receiver is beyond the predetermined distance from the object based on characteristics of the signal. If the receiver is determined to be beyond the predetermined distance, the activation circuitry is enabled.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic block diagram of an embodiment of the invention.

FIG. 2 is a schematic diagram of another embodiment of the receiver of FIG. 1.

FIG. 3 is a timing diagram for the transmitter of FIG. 1.

FIG. 4 is a timing diagram for the signal from the transmitter of FIG. 1 at the receiver of FIG. 2.

FIG. 5 is a timing diagram detailing the timing characteristics of an exemplary pulse cycle of the system of FIG. 1.

FIG. 6 is a flow diagram detailing the logical performance of the controller of FIG. 1.

### DETAILED DESCRIPTION OF THE PREFERRED EMBODIMENT

Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the description and the appended claims that follow.

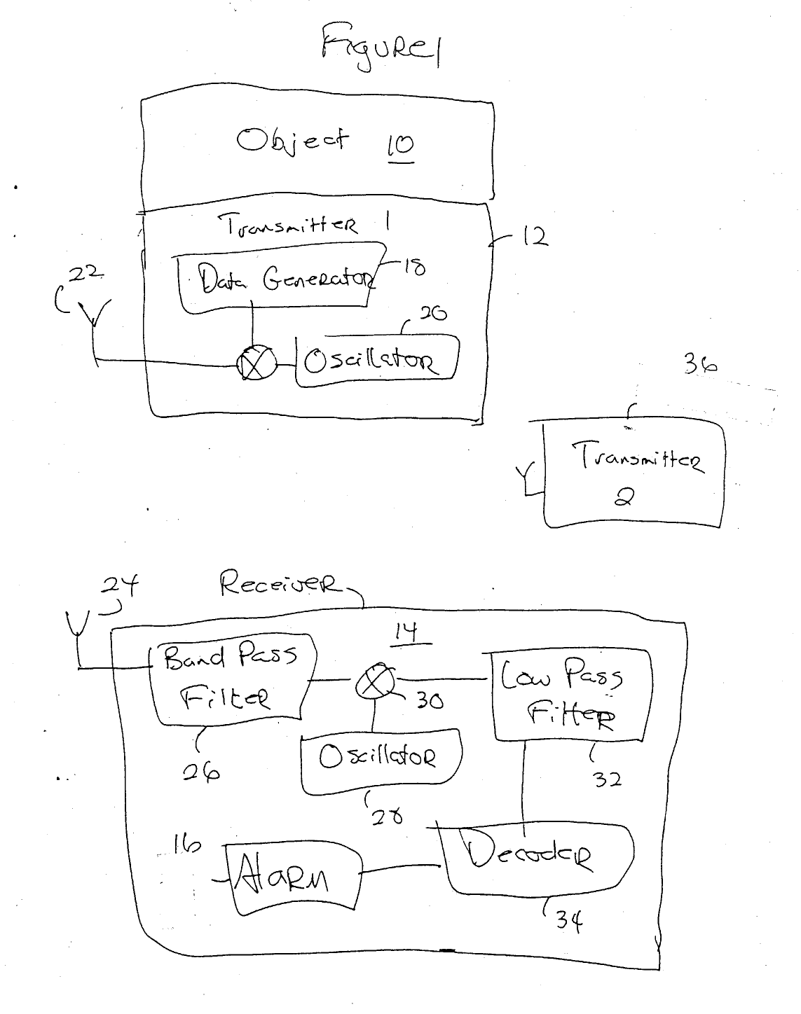

FIG. 1 is a schematic block diagram of an embodiment of the invention. The envisioned invention is a personal reminder for people who fear that they might lose their valuable things.

In the invention, a transmitter 12 is coupled to an object 10. A receiver 14 is carried on the personal space of a user. While the transmitter 12 and receiver 14 are within a predetermined distance of one another, no signal is generated. However, when the transmitter 12 and the receiver 14 are separated by more than a predetermined distance, the receiver 14 will actuate an alarm mechanism 16 associated with the receiver 14. In this manner, the user will know precisely when he is more than the predetermined distance from the object.

For example, if the user moves beyond the predetermined distance from the object 10, the alarm 16 actuates. This reminds the user that the object 10 is being left. As such, the object 10 will not be lost. The user may keep the object 10 at hand without ever having to actuate a finding mechanism. The act of keeping track of an object is performed without any extraneous action from the user.

The transmitter 12, as shown, has three main blocks. These are a data generator circuit 18 coupled to an oscillator circuitry 20. The output of the oscillator circuitry 20 is coupled to a transmission antenna 22.

The data generator 18 supplies a coded signal pulse. In one embodiment, the pulses switch the oscillator 20 on and off. This generates an amplitude shift-keying modulation of the coded pulse.

Of course, the description is not limited to amplitude shift-keying modulation. Many other types of modulation are possible, and should all be considered in the context of this invention.

The code can take many forms. In one case, the code is a 16-bit code. The first eight bits are a preamble, and the final eight bits are a code that identifies a particular transmitter. Of course, the length of the code may be any number, and the function of the various bits may be numerous.

In the case of the amplitude shift-keying type modulation, the receiver is designed using a direct conversion method. In this case, the wanted carrier frequency is filtered, amplified and mixed with a local oscillator frequency to produce the desired base band signal (the coded signal).

A band pass filter 26 is interposed after the signal is received in a reception antenna 28. This helps ensure that the received signal is the same carrier frequency from the respective transmitter. In other words, the signal is refined in a certain range before the demodulator processes it.

In one embodiment, the filter 26 is designed with its center frequency at 315 MHz with narrow bandwidth characterization (Q>10). Of course, depending on the country characteristics, the particular frequency may be altered to any of a number of frequencies.

A local oscillator 28 is interposed after the filter 26. The local oscillator 28 is designed to match the transmitter's signal carrier frequency. The signal from the local oscillator 28 is mixed with the signal from the band pass filter 26 in a mixer 30. The mixer 30 is used to extract the data frequency from the modulated signal.

In one embodiment, a low pass filter 32 is interposed after the mixer 30. The low pass filter 32 is used to filter out other frequencies except the data frequency.

A data decoder 34 receives the demodulated signal. The decoder 34 analyzes the signal from the low pass filter 30. If the data is invalid, the decoder 34 actuates the alarm 16 if the data received is invalid. Or, if no data is received from the specific transmitter 12 within some predetermined amount of time, the alarm 16 is actuated. Thus, when no signal is present from the specific transmitter 12 after a certain period of time, the alarm 16 actuates and informs the user that the transmission has ceased.

The data decoder 34 can be made with a programmable controller, operate in hardware, or be embodied in software. Or, it can operate with any combination of the above. The data codes can be used as a validity control and as an identification number for the respective transmitter and receiver system.

The data in the code can be used to discriminate objects. Thus the system may track more than one object based on differing ID codes. For example the transmitter 12 is designated as ID 5. Another transmitter 36 transmits the ID code of 6. In this manner, multiple objects may be tracked.

The receiver system 14 does nothing if valid data is received, otherwise the alarm 16 generates a sound. The validity of the data is true if the receiver is in the radius of signal coverage, and the result of the decided data is the same as the prefixed data in the receiver's memory.

The user typically holds the receiver 14. The transmitter 12 would typically be affixed on the property. Whenever the property is separated from the user more than the specified range (such as 0.01 to 50 meters), the indicator in the receiver 14 will be activated.

A laptop computer, a hand phone, a personal digital assistant, or any of the like, are some of the objects that can be fitted with the transmitter 12. The device can also be used as a simple tracker for pets or children in public places. If the user accidentally forgets about his laptop computer or hand phone, the receiver 14 instantly reminds him by producing a warning. This warning can be audible or visual in nature. The alarm an be any or a combination of an audio alarm, such as a piezo-electric beeper, a flashing light, a vibrator, or any other type of alarm that will gain the attention of the user.

The device can also be used to monitor movements of people and objects in a given coverage area. Security uses are also seen as some of the other applications: such as monitoring inmates in cells and restricted areas, passengers at terminals and boarding areas; employees and visitors in restricted zones. Another example is: Tracking of the location of the carriers of the transmitter by monitoring reception of the signals transmitted by the transmitter in a network of receivers distributed over secured zones under monitor. In this case, the receiver's would be distributed in the monitoring zone attached to various locations and not necessarily held by a specific person, and receiver connected to a network to identify the location of transmitter,

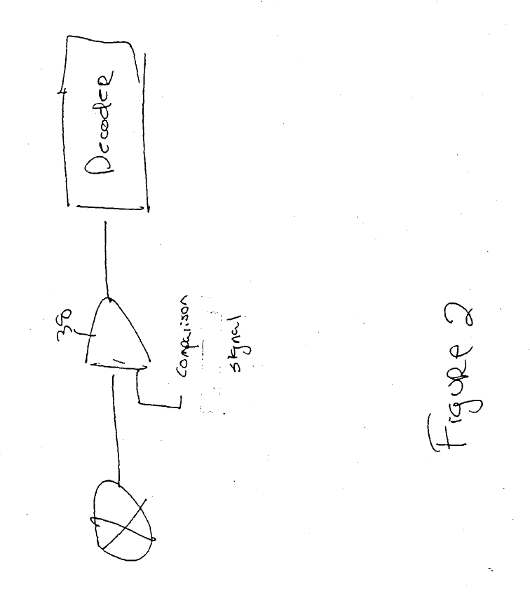

FIG. 2 is a schematic diagram of another embodiment of the receiver of FIG. 1. In this embodiment the signal from the receiver oscillator is put into a comparator 38. The comparator 38 outputs a signal based on the level of the received encoded signal. When the receiver 14 is removed from the area, the power of the received signal from the transmitter 12 is decreased. Thus, at greater distances, the comparator 38 will not register the code to the decoding circuitry.

In other embodiments, the components of the transmitter 12 may be dynamically altered to influence the power of the transmitted signal. Or, the power may be increased through modulation, such as the pulse waveform modulation. In this manner, the power transmitted may be dynamically altered to provide varying distance thresholds for the system. Of course, some of these portions may be altered by remote actuation.

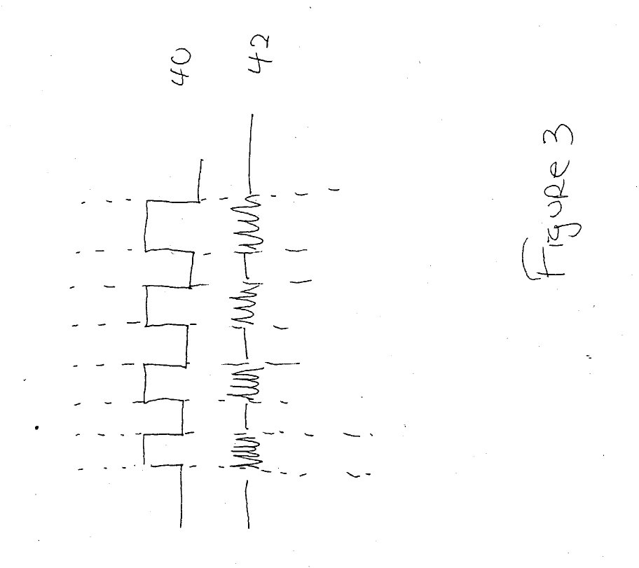

FIG. 3 is a timing diagram for the transmitter of FIG. 1. Line 40 shows the output of the coding circuitry as a digital signal of logical highs and lows. Line 42 shows the amplitude shift-keying type modulation of the signal from line 40. The signal from line 42 is propagated through the antenna.

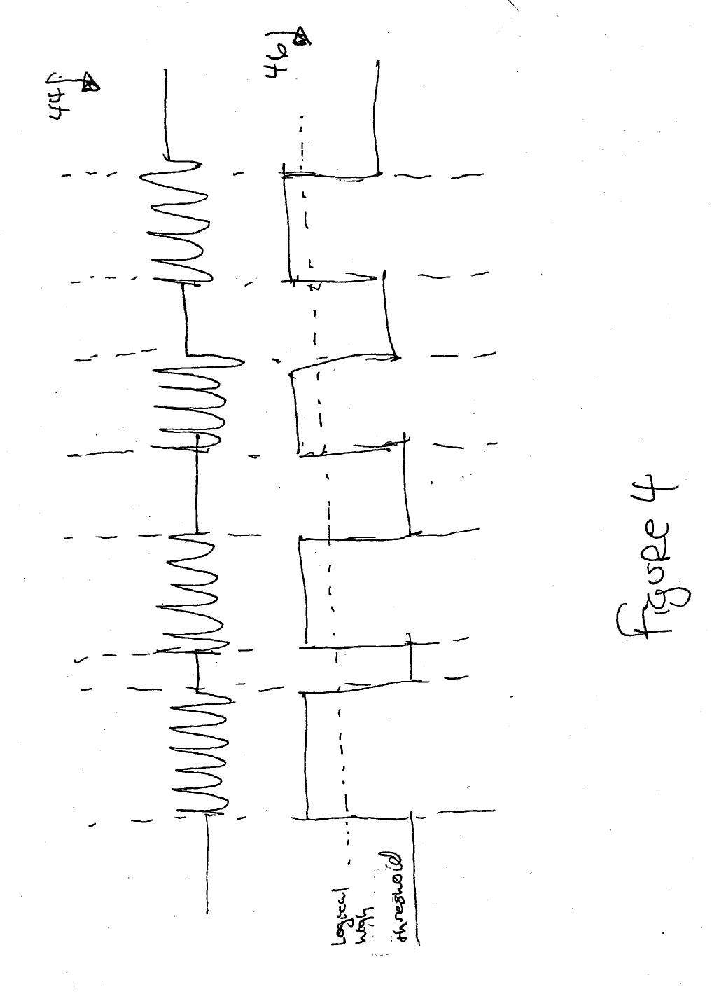

FIG. 4 is a timing diagram for the signal from the transmitter of FIG. 1 at the receiver of FIG. 2. Line 44 is the received signal at the antenna. Line 46 shows the received signal from line 44 at the comparator output, when the receiver is within the predetermined distance. In this case, the original signal is strong enough to be detected at the comparator. As such, the code is forwarded to the control circuitry for comparison.

In some cases, the transmitter is further than the prescribed distance. As such, no discernible logical code is recovered at the comparator. Thus, the absence of a proper code at the controller will actuate the alarm.

It should be noted that if a resetting of the comparator to a different level is performed, the signal could mirror that of line 46. At the new comparator level, or new broadcast power level, the previously non-discernible signal is now discernable. This allows the unit to be dynamically set for varying distances. Of course, other means of varying the distance can be used.

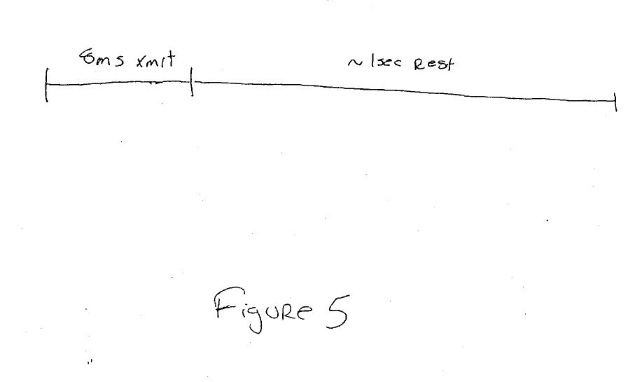

FIG. 5 is a timing diagram detailing the timing characteristics of an exemplary pulse cycle of the system of FIG. 1. In this embodiment, a burst code pulse of 8 ms is initiated. This is followed by a pause cycle of approximately 1-second. In this manner, the entire system does not use an exorbitant amount of power.

The units may be manufactured as stand alone units, or may be incorporated into the board or circuit space of other units. In this manner, the circuitries may piggyback into the production process. Of course, the power used by the units may be stand-alone to the units, or the power source of the mother object can be tapped into.

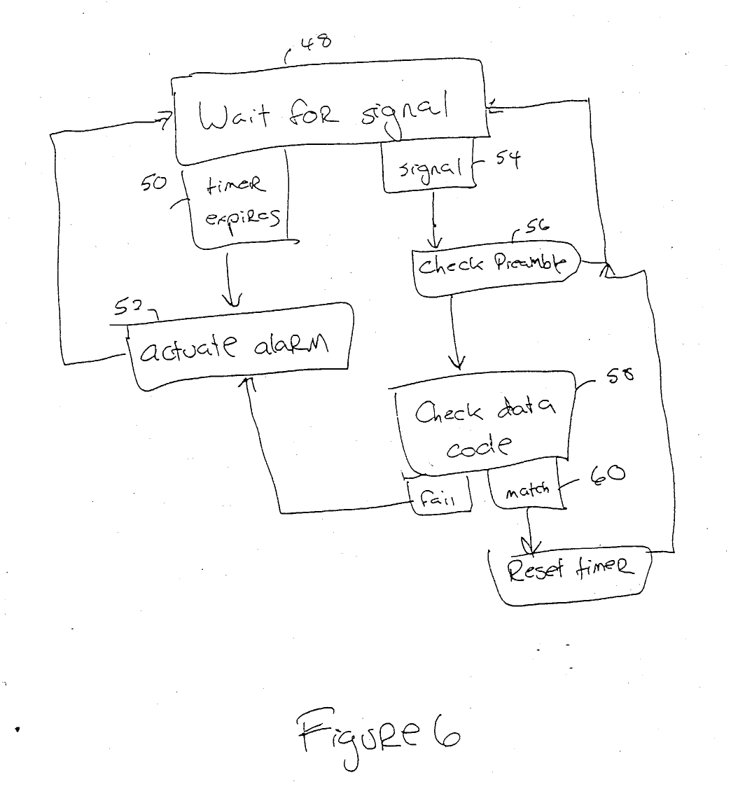

FIG. 6 is a flow diagram detailing the logical performance of the controller of FIG. 1. In a block 48, a decoder awaits a signal. In a block 50 a timer, corresponding to the transmit and wait time of FIG. 5 expires. In this case an alarm is actuated in a block 52. In some cases the timer can expire some predetermined times before actually actuating the alarm.

In a block 54, a signal is received. In a block 56 the preamble is checked. If there is no match, the system recycles. On a match, the transmitter code is checked in a block 58. On a match 60, the system recycles. This can also reset the timer associated with the block 50. If the match fails, the alarm is actuated.

Thus, an apparatus and method for a wireless location device is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

We claim:

1. A system for wirelessly determining that an object is within a predetermined distance from a user, the system comprising:
a transmitter, associated with the object, having a transmitting circuitry that transmits a signal independently of the location of the transmitter; and
a receiver, associated with the user, the receiver comprising:
a receiving circuitry that receives the signal;
an activation circuitry that alerts the user; and
a logical circuitry, communicatively coupled to the receiving circuitry and the activation circuitry, that determines whether the receiver is beyond the predetermined distance from the object based on characteristics of the signal, and if the receiver is determined to be beyond the predetermined distance, enables the activation circuitry.

2. The system of claim 1 wherein the signal contains a code.

3. The system of claim 2 wherein the logical circuitry determines if the code has been received.

4. The system of claim 1 wherein the signal is transmitted on a predetermined periodic basis.

5. A system for wirelessly determining that an object is within a predetermined distance from a user, the system comprising:
a transmitter, associated with the object, having a transmitting circuitry that transmits a signal on a predetermined basis; and
a receiver, associated with the user, the receiver comprising:
a receiving circuitry that receives the signal;
an activation circuitry that alerts the user; and
a logical circuitry, communicatively coupled to the receiving circuitry and the activation circuitry, that enables the activation circuitry in the absence of receiving the transmitted signal.

6. The system of claim 5 wherein the signal contains a code.

7. The system of claim 6 wherein the logical circuitry determines if the code has been received.

8. The system of claim 5 wherein the signal is transmitted on a predetermined periodic basis.

9. The system of claim 1 wherein the signal is transmitted continuously.

10. A receiver for wirelessly determining that an object is within a predetermined distance from a user, a transmitter associated with the object transmitting signal, the receiver comprising:
a receiving circuitry that receives the signal;
an activation circuitry that alerts the user; and
a logical circuitry, communicatively coupled to the receiving circuitry and the activation circuitry, that enables the activation circuitry in the absence of receiving the transmitted signal.
